(19) United States
(12) Patent Application Publication
(10) Pub. No.: US 2024/0163726 A1
(43) Pub. Date: May 16, 2024

(54) MECHANISM FOR RECEIVE ORDERING BUFFER CONTROL OPERATION

(71) Applicant: MEDIATEK INC., Hsin-Chu (TW)

(72) Inventors: Wei-Wen Lin, Hsinchu City (TW); Hsi-Chang Yang, Hsinchu City (TW)

(73) Assignee: MEDIATEK INC., Hsin-Chu (TW)

(21) Appl. No.: 18/504,100

(22) Filed: Nov. 7, 2023

Related U.S. Application Data
(60) Provisional application No. 63/383,118, filed on Nov. 10, 2022.

(51) Int. Cl. H04W 28/14; H04L 47/62

(52) U.S. Cl. CPC H04W 28/14; H04L 47/622

(57) ABSTRACT

The present invention provides a control method of an electronic device, wherein the control method includes the steps of: establishing pre-linked buffers in a memory; wirelessly receiving a frame; generating a plurality of MPDUs according to the frame, wherein each of the MPDUs comprises at least one MSDU; writing the MSDUs of the plurality of MPDUs into the pre-linked buffers, wherein each buffer is configured to store one MSDU; generating a command to read in-order MPDUs from the memory if the memory has the in-order MPDUs.

### CROSS REFERENCE TO RELATED APPLICATIONS

This application claims the benefit of U.S. Provisional Application No. 63/383,118, filed on Nov. 10, 2022. The content of the application is incorporated herein by reference.

### BACKGROUND

In a wireless communication module of an electronic device, the received packets are temporarily stored in a memory, and the packets are transmitted to a following circuitry if the memory has in-order packets. Because the received packets may be out of order, the wireless communication module has a reorder engine to perform the packet reordering operation such as “receive reordering buffer control operation” in IEEE 802.11 specification. However, when the packets are temporarily stored in the memory, the wireless communication module needs to establish many links between the buffers for respectively storing the packets in a real-time manner, causing higher computing power of the electronic device.

### SUMMARY

It is therefore an objective of the present invention to provide a wireless communication, which uses pre-linked buffers to store the received packets, to solve the above-mentioned problems.

According to one embodiment of the present invention, a control method of an electronic device comprises the steps of: establishing pre-linked buffers in a memory; wirelessly receiving a frame; generating a plurality of media address control protocol data units (MPDU) according to the frame, wherein each of the MPDUs comprises at least one medium access control service data unit (MSDU); writing the MSDUs of the plurality of MPDUs into the pre-linked buffers, wherein each buffer is configured to store one MSDU; generating a command to read in-order MPDUs from the memory if the memory has the in-order MPDUs.

According to one embodiment of the present invention, an electronic device comprising a host controller, a memory and a wireless communication module is disclosed. The host controller establishes pre-linked buffers in the memory; the wireless communication module wirelessly receives a frame, and generates a plurality of media address control protocol data units (MPDU) according to the frame, wherein each of the MPDUs comprises at least one medium access control service data unit (MSDU); the wireless communication module writes the MSDUs of the plurality of MPDUs into the pre-linked buffers, wherein each buffer is configured to store one MSDU; the wireless communication module generates a command if the memory has in-order MPDUs; and the host controller reads the in-order MPDUs from the memory according to the command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system according to one embodiment of the present invention.

FIG. 2 is a flowchart of a control method of the AP according to one embodiment of the present invention.

FIG. 3 shows pre-linked buffers according to one embodiment of the present invention.

FIG. 4 shows writing MSDUs of MPDUs into the pre-linked buffers according to one embodiment of the present invention.

FIG. 5 shows an address-element table according to one embodiment of the present invention.

FIG. 6 is a flowchart of a control method of the AP according to one embodiment of the present invention.

FIG. 7 shows a detailed structure of the AP according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

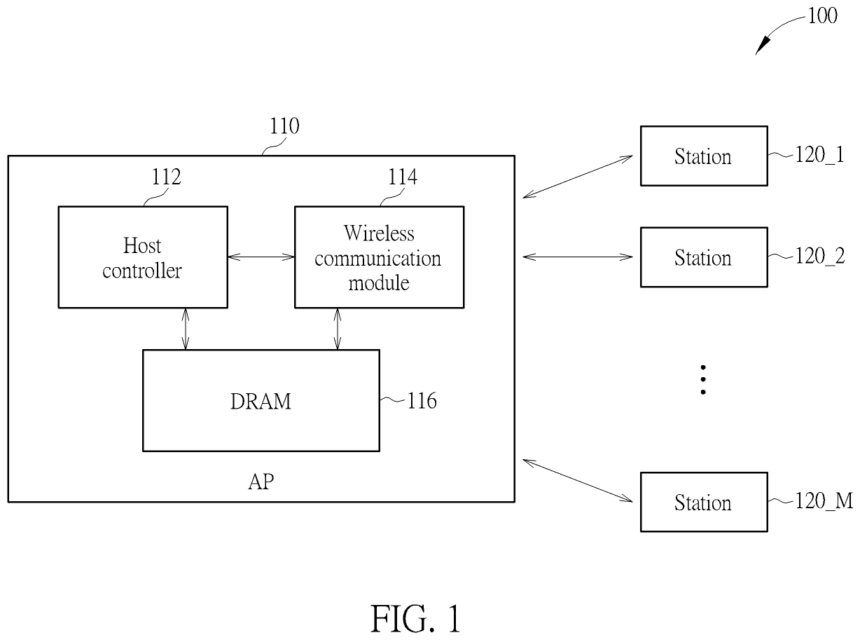

FIG. 1 is a diagram illustrating a wireless communication system 100 according to one embodiment of the present invention. As shown in FIG. 1, the wireless communication system 100 comprises an access point (AP) 110 and a plurality of stations 120_1-120_M, wherein the stations 120_1-120_M are capable of wirelessly communicated with the AP 110 by using multi-link operation defined in Wi-Fi 7 specification. In addition, the AP 110 comprises a host controller 112, a wireless communication module 114 and a memory (in this embodiment, a dynamic random access memory (DRAM) 116 serves as the memory), wherein the host controller 112 can be implemented by using a processing circuit, and the wireless communication module 114 comprises a medium access control (MAC) layer circuitry and a physical layer circuitry.

In this embodiment, the AP 110 and the stations 120_1-120_M are multi-link devices (MLD) supporting Wi-Fi 7 specifications, that is the AP 110 and the stations 120_1-120_M are communicated with each other by using two or more links. In this embodiment, one of the links may use a channel corresponding to a 2.4 GHz band (e.g., 2.412 GHz-2.484 GHz), a 5 GHz band (e.g., 4.915 GHz-5.825 GHz) or a 6 GHz band (e.g., 5.925 GHz-7.125 GHz); and the other link may also use a channel corresponding to the 2.4 GHz band, the 5 GHz band or the 6 GHz band.

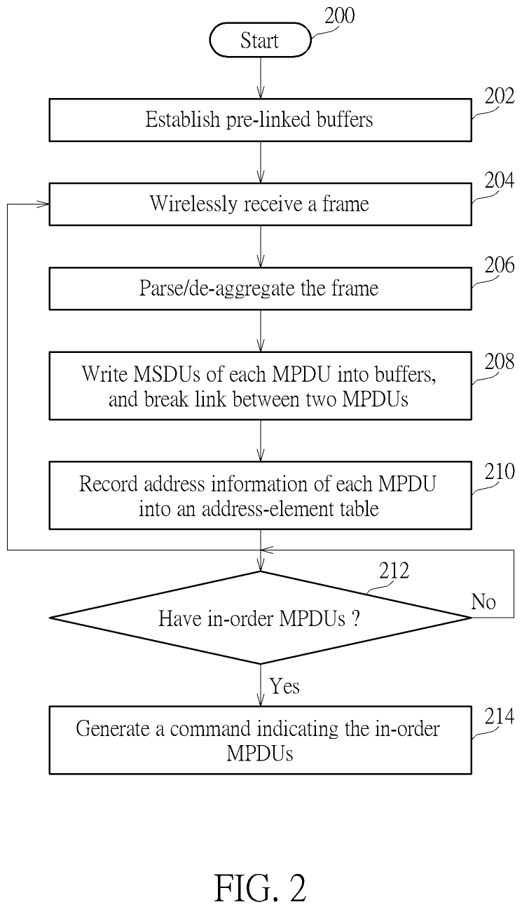

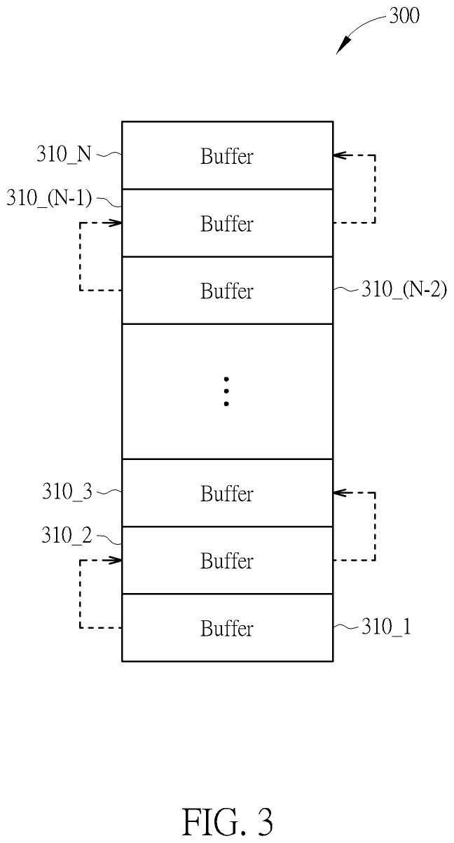

FIG. 2 is a flowchart of a control method of the AP 110 according to one embodiment of the present invention. In Step 200, the flow starts, and the AP 110 has established links with at least one of the stations 120_1-120_M. In Step 202, the host controller 112 establishes pre-linked buffers within the DRAM 116. Specifically, referring to FIG. 3, the host controller 112 arranges a plurality of buffers 310_1-310_N, wherein each of the buffers 310_1-310_N is used to store one packet, and one packet indicates one MAC service data unit (MSDU) in this embodiment. Furthermore, the host controller 112 establishes links between two adjacent buffers so that each buffer is linked to a next buffer or a previous buffer. Taking the pre-linked buffers 300 shown in FIG. 3 as an example, each buffer has a physical address, and the buffer 310_1 is linked to the buffer 310_2, the buffer 310_2 is linked to the buffer 310_3, . . . , the buffer 310 (N−2) is linked to the buffer 310 (N−1), and the buffer 310 (N−1) is linked to the buffer 310_N. It is noted that, initially the pre-linked buffers 300 do not store any received data, that is each buffer is empty or stores invalid data.

In Step 204, the wireless communication module 114 receives one or more frames from at least one of the stations 120_1-120_M, wherein the frames are complied with IEEE 802.11 specification, and each frame is a physical protocol data unit (PPDU) frame.

In Step 206, the wireless communication module 114 parses the received frame, and performs de-aggregation operation and decoding operation upon the received frame to generate a plurality of MSDUs sequentially. Specifically, the PPDU comprises a plurality of MAC protocol data units (MPDU), and each MPDU comprises at least one MSDU, so the wireless communication module 114 de-aggregates and decodes the PPDU to generate MSDUs. In addition, the PPDU has a transmitting address (TA) (i.e., which station sends this PPDU) and a traffic identity (TID), and each MPDU has a sequence number (SN), so each of the generated MSDUs has the information of above mentioned TA, TID and SN. It is noted that the operations of parsing, de-aggregating and decoding the received frame are known by a person skilled in the art, so the detailed descriptions of these operations are omitted here.

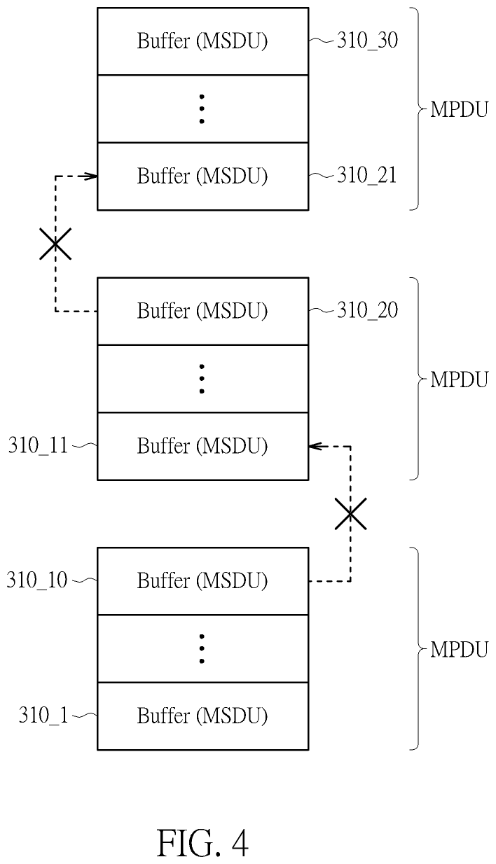

In Step 208, the wireless communication module 114 obtains the information of the pre-linked buffers 300 from the host controller 112, and the wireless communication module 114 writes the generated MSDUs into the buffers in sequence. In detail, referring to FIG. 4, assuming that each MPDU has ten MSDUs (not a limitation of the present invention), the wireless communication module 114 writes ten MSDUs of a first MPDU into the buffers 310_1-310_10 according to the information of the pre-linked buffers 300. It is noted that because the buffers 310_1-310_10 have linked before, the wireless communication module 114 does not need to establish links when writing these MSDUs into the DRAM 116, that is the ten MSDUs can be directly written into the buffers 310_1-310_10 in sequence. Then, after the last MSDU of the first MPDU is written into the buffer 310_10, the wireless communication module 114 breaks the link between the buffer 310_10 storing the last MSDU of the first MPDU and the next buffer 310_11.

Similarly, the wireless communication module 114 writes ten MSDUs of a second MPDU into the buffers 310_11-310_20 according to the information of the pre-linked buffers 300, and after the last MSDU of the second MPDU is written into the buffer 310_20, the wireless communication module 114 breaks the link between the buffer 310_20 storing the last MSDU of the second MPDU and the next buffer 310_21. Then, the wireless communication module 114 writes ten MSDUs of a third MPDU into the buffers 310_21-310_30 according to the information of the pre-linked buffers 300, and after the last MSDU of the third MPDU is written into the buffer 310_30, the wireless communication module 114 breaks the link between the buffer 310_30 storing the last MSDU of the third MPDU and the next buffer 310_31, and so on.

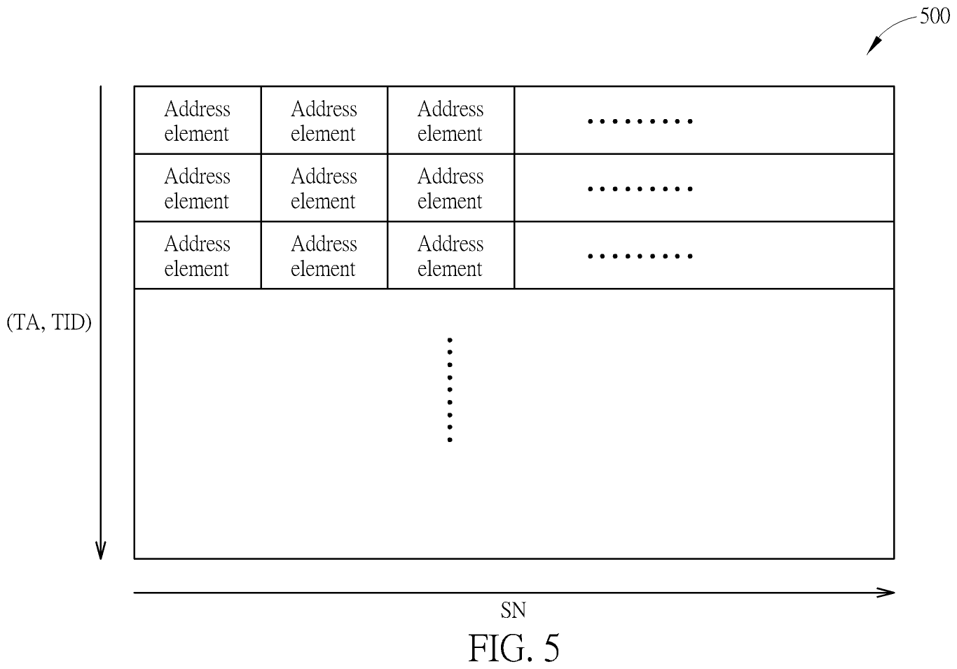

In Step 210, the wireless communication module 114 records address information of each MPDU stored in the DRAM 116 in an address-element table 500 shown in FIG. 5. As shown in FIG. 5, each row of the address-element table 500 corresponds to one TA and one TID, and each row has a plurality of address elements. In this embodiment, for one row of the address-element table 500, each address element corresponds to one MPDU, and the address elements from left to right are used to store information of the MPDUs with sequence numbers from low to high. In this embodiment, each address element comprises a head address and an MSDU count of one MPDU. For example, for one row of the address-element table 500, the first address element stores the address of the buffer 310_1 and MSDU count (i.e., ten MSDUs) of the first MPDU with sequence number “1”, the second address element stores the address of the buffer 310_11 and MSDU count “10” of the second MPDU with sequence number “2”, the third address element stores the address of the buffer 310_21 and MSDU count “10” of the third MPDU with sequence number “3”, and so on.

After Step 210, the flow goes back to Step 204 to receive the next frame. Meanwhile, the flow can enter Step 212 to determine if DRAM 116 stores in-order MPDUs. In this embodiment, the MPDUs need to be read in order starting from the lowest sequence number by the host controller 112, so if the DRAM 116 stores the MPDUs with the sequence number “1”, “2”, “3”, “4” and “5”, it means that the DRAM 116 have the in-order MPDUs. In addition, if the DRAM 116 stores the MPDUs with the sequence number, “2”, “3”, “4” and “5”, and the MPDU with the sequence number “1” is missed (i.e., MPDU with the sequence number “1” was not successfully decoded, and the MPDU with the sequence number “1” will be obtained in the next PPDU frame), the wireless communication module 114 determines that the DRAM 116 does not have the in-order MPDUs. If the DRAM 116 has the in-order MPDUs, the flow enters Step 214; and if the DRAM 116 does not have the in-order MPDUs, the flow stays at Step 212. In one embodiment, without a limitation of the present invention, the wireless communication module 114 records the sequence numbers of the successfully decoded MPDUs in an internal buffer or another storage unit, and the wireless communication module 114 can determine if the DRAM 116 stores the in-order MPDUs according these sequence numbers of the successfully decoded MPDUs.

In Step 214, the wireless communication module 114 generates a command indicating information of the in-order MPDUs, and the command is stored in the DRAM 116. For example, the command comprises the start sequence number of the in-order MPDUs, the MPDU count, and TA and TID corresponding to the in-order MPDUs. For example, if the DRAM 116 stores the MPDUs with the sequence number “1”, “2”, “3”, “4” and “5”, the wireless communication module 114 generates the command having the start sequence number “1” of the MPDU, the MPDU count “5” and corresponding TA and TID.

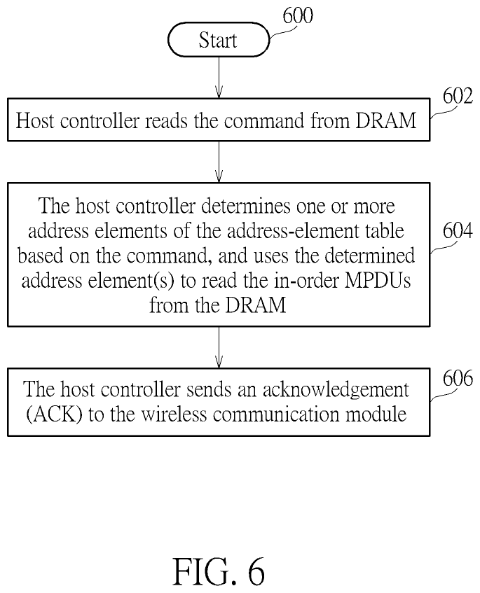

FIG. 6 is a flowchart of a control method of the AP 110 according to one embodiment of the present invention. In Step 600, the flow starts. In Step 602, the host controller 112 reads the command(s) from the DRAM 116, wherein the command was written by the wireless communication module 114 in Step 214. In Step 604, the host controller 112 determines one or more address elements of the address-element table 500 based on the command, and uses the determined address element(s) to read the in-order MPDUs from the DRAM 116. In detail, because the command comprises the start sequence number of the in-order MPDUs, the MPDU count, and TA and TID corresponding to the in-order MPDUs, the host controller 112 can determine the address elements of the address-element table 500 based on the above information. Then, because each address element comprises a head address and an MSDU count of one MPDU, the host controller 112 can determine the addresses of the buffers corresponding to all of the MSDUs of the MPDU(s). Then, the host controller 112 reads all of the MSDUs of the MPDU(s) based on the determined addresses of the buffers in sequence.

Taking FIG. 4 as an example, if the host controller 112 determines the addresses of the buffers 310_1-310_30 corresponding to all of the MSDUs of the MPDU(s), the host controller 112 reads the contents of the buffers 310_1-310_30 in sequence. In addition, after all of the MSDUs of the MPDU(s) are successfully read by the host controller 112 in step 604, the buffers storing these MSDUs are released at any appropriate time so that the buffers (pre-linked buffers) can be used by the following received MSDUs.

In Step 606, the host controller 112 sends an acknowledgement (ACK) to the wireless communication module 114 to indicate that the command has been executed, and the command previously executed can be deleted from the DRAM 116.

In addition, when all of the MPDUs within one PPDU are read by the host controller 112, the host controller 112 can send a reset command to reset the address elements.

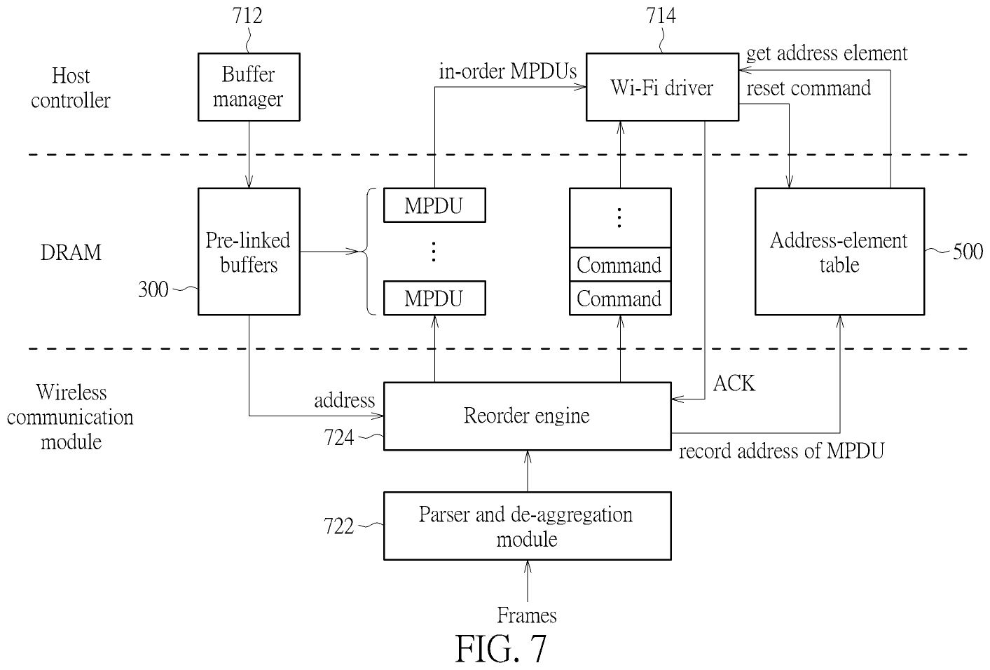

FIG. 7 shows a detailed structure of the AP 110 according to one embodiment of the present invention. As shown in FIG. 7, the host controller 112 is a processing circuit having a buffer manager 712 and a Wi-Fi driver 714, the wireless communication module 114 comprises a parser and de-aggregation module 722 and a reorder engine 724. The operations of the embodiment shown in FIG. 7 are similar to the above embodiments shown in FIG. 2-FIG. 6. Specifically, the buffer manager 712 is configured to establish pre-linked buffers 300 within the DRAM 116, and the reorder engine 724 can get the information of the pre-linked buffers 300. The parser and de-aggregation module 722 parses the received frame, and performs de-aggregation operation and decoding operation upon the received frame to generate a plurality of MSDUs sequentially, and the reorder engine 724 writes the generated MSDUs into the buffers in sequence, and the reorder engine records address information of each MPDU stored in the DRAM 116 in the address-element table 500. Then, if the DRAM 116 stores in-order MPDUs, the reorder engine 724 generates a command indicating information of the in-order MPDUs, and the Wi-Fi driver 714 reads the MPDUs from the DRAM 116 based on the command. Finally, the Wi-Fi driver 714 sends an acknowledgement (ACK) to the reorder engine 724 to indicate that the command has been executed.

The above embodiments are described in terms of the access point 110, however it's not a limitation of the present invention. In another embodiment, the above embodiments of FIG. 2 and FIG. 6 can be executed by a station such as 120_1-120_M or any non-AP station.

Briefly summarized, in the control method of the AP of the present invention, by setting pre-linked buffers to store the MSDUs, the wireless communication module does not need to establish links when writing these MSDUs into the DRAM, so the computing power of the AP can be reduced. In addition, by designing an address-element table to record the address of each MPDU stored in the DRAM, the host controller can read the MPDUs from the DRAM efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of an electronic device, comprising:
establishing pre-linked buffers in a memory;
wirelessly receiving a frame;
generating a plurality of media address control protocol data units (MPDU) according to the frame, wherein each of the MPDUs comprises at least one medium access control service data unit (MSDU);
writing the MSDUs of the plurality of MPDUs into the pre-linked buffers, wherein each buffer is configured to store one MSDU;
generating a command to read in-order MPDUs from the memory if the memory has the in-order MPDUs.

2. The control method of claim 1, further comprising:
establishing an address-element table; and
recording address information of each of the MPDUs stored in the memory in the address-element table.

3. The control method of claim 2, wherein the address-element table comprises a plurality of address elements, each address element is used to store the address information of one MPDU; and the address information of each MPDU comprises a head address and an MSDU count of the MPDU.

4. The control method of claim 3, wherein the plurality of address elements correspond to a plurality of sequence numbers of MPDUs, respectively; and the command comprises a start sequence number of the in-order MPDUs, and the MPDU count of the in-order MPDUs.

5. The control method of claim 4, further comprising:
determining one or more address elements of the address-element table based on the command; and
using the determined address element(s) to read the in-order MPDUs from the memory.

6. The control method of claim 1, wherein the electronic device is an access point (AP), and the memory is a dynamic random access memory (DRAM).

7. An electronic device, comprising:
a host controller;
a memory; and
a wireless communication module;
wherein the host controller establishes pre-linked buffers in the memory; the wireless communication module wirelessly receives a frame, and generates a plurality of media address control protocol data units (MPDU) according to the frame, wherein each of the MPDUs comprises at least one medium access control service data unit (MSDU); the wireless communication module writes the MSDUs of the plurality of MPDUs into the pre-linked buffers, wherein each buffer is configured to store one MSDU; the wireless communication module generates a command if the memory has in-order MPDUs; and the host controller reads the in-order MPDUs from the memory according to the command.

8. The electronic device of claim 7, wherein the host controller establishes an address-element table, and the wireless communication module records address information of each of the MPDUs stored in the memory in the address-element table.

9. The electronic device of claim 8, wherein the address-element table comprises a plurality of address elements, each address element is used to store the address information of one MPDU; and the address information of each MPDU comprises ahead address and an MSDU count of the MPDU.

10. The electronic device of claim 9, wherein the plurality of address elements correspond to a plurality of sequence numbers of MPDUs, respectively; and the command comprises a start sequence number of the in-order MPDUs, and the MPDU count of the in-order MPDUs.

11. The electronic device of claim 10, wherein the host controller determines one or more address elements of the address-element table based on the command, and uses the determined address element(s) to read the in-order MPDUs from the memory.

12. The electronic device of claim 7, wherein the electronic device is an access point (AP), and the memory is a dynamic random access memory (DRAM).
